(19) United States
(12) Patent Application Publication
(10) Pub. No.: US 2016/0301806 A1
(43) Pub. Date: Oct. 13, 2016

(54) HANDSFREE PHONE CALL DEVICE

(71) Applicant: HOSIDEN CORPORATION, Osaka (JP)

(72) Inventors: Yoshifumi Yamanaka, Osaka (JP); Shunji Muraoka, Osaka (JP)

(21) Appl. No.: 15/005,164

(22) Filed: Jan. 25, 2016

(30) Foreign Application Priority Data
Apr. 8, 2015 (JP) 2015079363

(51) Int. Cl. H04M 9/08; H04M 1/60

(52) U.S. Cl. CPC H04M 9/082; H04M 1/6083

(57) ABSTRACT

A handsfree phone call device includes a reporting terminal unit that outputs a user's phone call via a phone terminal unit through a speaker, a relaying module that relays communication between the phone terminal unit and the reporting terminal unit, a pair of signal lines that are capable of supplying power from one of the relaying module and the reporting terminal unit to the other, a wired relaying section that transmits a received call signal via the pair of signal lines to the reporting terminal unit, a voice signal transmitting section that transmits a voice signal based on the received call signal via the pair of signal lines to the relaying module, and an echo cancelling section that reduces, by means of the voice signal, an echo that is generated according to the received call signal outputted through the speaker.

### CROSS REFERENCE TO RELATED APPLICATION

This application is based on and claims priority under 35 U.S.C. Section 119 to Japanese Patent Application No. 2015-079363 filed on Apr. 8, 2015, the entire contents of which are incorporated herein by reference.

### TECHNICAL FIELD

The disclosure relates to a handsfree phone call device configured to output a phone call by a user using a phone terminal unit through a speaker included a reporting terminal unit.

### RELATED ART

In a situation where phone terminal units such as mobile phones are being widely used, in consideration to the risk that a phone call made by a driver who is driving a vehicle or the like through a phone terminal unit held in his/her hand may jeopardize this driver's vehicle driving operation, a handsfree phone call device has been used. As an example of this kind of technique, a technique disclosed in JP2013-168845A is known.

A car-mounted handsfree phone call device disclosed in JP2013-168845A is provided with a speaker and a microphone. When a mobile phone (a “phone terminal unit”) receives a call and a handsfree phone communication is started, the received voice received via the mobile phone is forwarded to a communication interface of the car-mounted handsfree device and outputted through the speaker included in this car-mounted handsfree device. On the other hand, a speech voice inputted via the microphone is forwarded from the communication interface of the car-mounted handsfree device to the mobile phone call device to be transmitted therefrom to a terminal unit device of the other party.

### SUMMARY

According to the technique disclosed in JP 2013-168845A, a handsfree phone call through the phone terminal unit is possible However, when a phone call is received by the phone terminal unit and its speech voice is outputted through the speaker of the car-mounted handsfree device, a howling or echo phenomenon may occur when this speech voice is inputted to the microphone of the phone terminal unit. As a result, phone call quality of the phone terminal unit will deteriorate. Then, it is conceivable to temporarily stop output of the speech voice through the speaker of the car-mounted handsfree device and to transmit this speech voice from the phone terminal unit to the communication interface section of the car-mounted handsfree device first and then to transmit it from this communication interface section to the phone terminal unit. However, transmission of speech voice to the communication interface section from the speaker of the car-mounted handsfree device requires a special cable therefor, thus it can result in increase of the weight of the device or increase of cost thereof.

Embodiments of the present invention comprise a handsfree phone call device that does not impair the quality of phone call and that also can be realized with light weight and lower costs.

A handsfree phone call device according to this disclosure comprises:

a reporting terminal unit that outputs a user's phone call via a phone terminal unit through a speaker;

a relaying module that relays communication between the phone terminal unit and the reporting terminal unit by effecting communication with the phone terminal unit and effecting also wired communication with the reporting terminal unit;

a pair of signal lines that connect between the relaying module and the reporting terminal unit and that also are capable of supplying power from one of the relaying module and the reporting terminal unit to the other;

a wired relaying section included in the relaying module, the wired relaying section transmitting a received call signal transmitted from the phone terminal unit to the relaying module via the pair of signal lines to the reporting terminal unit;

a voice signal transmitting section included in the reporting terminal unit, the voice signal transmitting section transmitting a voice signal based on the received call signal via the pair of signal lines to the relaying module; and

an echo cancelling section included in the relaying module, the echo cancelling section reducing, by means of the voice signal, an echo that is generated when the received call signal outputted through the speaker is inputted to a microphone included in the relaying module.

In the case of the above-described arrangement, the echo cancelling section reduces generation of echo with effective utilization of the voice signal transmitted from the reporting terminal unit. Thus, deterioration of phone call quality in the phone terminal unit can be prevented. Further, the pair of signal lines can be used not only as cables for supplying electric power to the relaying module or the reporting terminal unit, but also as cables for transmitting and receiving signals between the relaying module and the reporting terminal unit. Therefore, as compared with an arrangement of not co-utilizing these cables, the number of cables to be used can be reduced, so that the handsfree phone call device can be made light-weighted and manufactured at lower costs.

Further, according to one embodiment of the handsfree phone call device, the pair of signal lines can comprise car-mounted audio bus cables.

In this case, even when e.g. three or more units are provided, these units can be simply connected in series. Thus, the number and the length of the cables used can be reduced. Therefore, it becomes possible to reduce the weight of the handsfree phone call device.

Further, according to one embodiment of the handsfree phone call device, the voice signal transmitting section can be configured to transmit the voice signal in the form of a differential signal through the pair of signal lines to the relaying module.

In this case, a received call signal can be transmitted in the form of a differential signal from the relaying module to the reporting terminal unit. Further, the voice signal based on the received call signal too can be transmitted in the form of a differential signal from the reporting terminal unit to the relaying module. As such differential signal is a digital signal, transmission is made possible with effective prevention of a distortion or deterioration of a signal which would otherwise occur in an analog signal such as the voice signal in the reporting terminal unit. Therefore, through execution of a high-quality digital signal processing in the reporting terminal unit, signal distortion or signal deterioration can be prevented, so that echo generation can be eliminated entirely.

According to one embodiment of the handsfree phone call device, the voice signal transmitting section can be configured to transmit also a voice signal other than the received call signal outputted through the speaker to the relaying module via the pair of signal lines that transmit the voice signal based on the received call signal.

In this case, it is possible to reduce generation of an echo that results from various sounds from e.g. a radio or a TV set outputted through the speaker included in the reporting terminal unit. Therefore, phone call quality deterioration in the phone call terminal can be prevented.

According to one embodiment of the handsfree phone call device, the relaying module can comprise a signal unit integrated with the phone terminal unit.

In this case, the relaying module and the phone terminal unit can be formed as a signal unit, so that the handsfree phone call device can be formed compact. Therefore, the handsfree phone call device can be formed light-weighted.

### BRIEF DESCRIPTION OF THE DRAWINGS

FIG. 1 is a block diagram schematically showing a configuration of a handsfree phone call device, and

FIG. 2 is a flowchart illustrating a processing effected by the handsfree phone call device.

### DESCRIPTION OF EMBODIMENTS

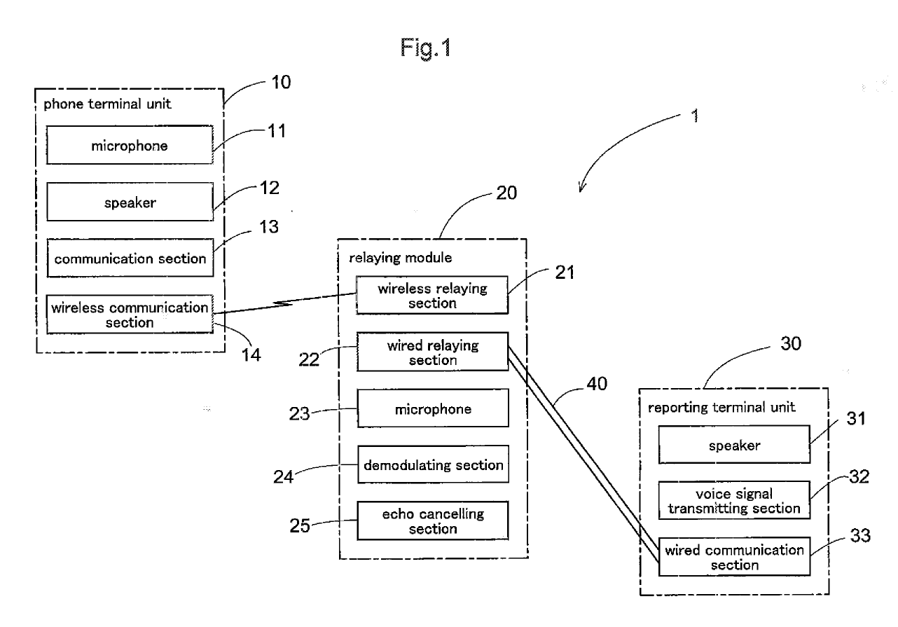

A handsfree phone call device relating to this disclosure has a function of outputting a user's phone call via a phone terminal unit through a speaker included in a reporting terminal unit and this device is formed light-weight and at low costs. Next, a handsfree phone call device 1 according to this embodiment will be explained. FIG. 1 shows a block diagram schematically showing a configuration of the handsfree phone call device 1 according to the instant embodiment. As shown in FIG. 1, the handsfree phone call device 1 includes a relaying module 20, a pair of signal lines 40, and a voice signal transmitting section 32.

The relaying module 20 relays communication between a phone terminal unit 10 and a reporting terminal unit 30. Here, the phone terminal unit 10 means a terminal unit capable of phone call and corresponds specifically to a mobile phone, a smartphone or the like. The phone terminal unit 10, as shown in FIG. 1, includes a microphone 11, a speaker 12, a communication section 13 and a wireless communication section 14.

The microphone 11 collects voice relating to a phone call conducted via the phone terminal unit 10 and converts it into a voice signal. The speaker 12 converts the voice signal received by the phone terminal unit 10 from a further phone terminal unit (corresponding to what is referred to as “received call signal” in this disclosure) into a voice and outputs this. The communication section 13 transmits and receives the voice signal handled in the microphone 11 and the speaker 12 with other phone terminal unit. The wireless communication section 14 effects wireless communication with the relaying module 20.

The relaying module 20 is configured to effect communication with the phone terminal unit 10 configured as described above. Meanwhile, communication between the relaying module 20 and the phone terminal unit 10 can be either wireless or wired communication. Here, the wireless communication refers to a mode of communication wherein signals transmitted therebetween are propagated in the air; and the wired communication refers to a mode of communication wherein signals are propagated or transmitted with use of a signal line. In this embodiment, there will be explained an example of the phone terminal unit 10 and the relaying module 20 effecting wireless communication therebetween. When the communication is effected in the form of wired communication, a wired communication section will be provided instead of the wireless communication section 14 described above. In such case, a wireless relaying section 21 of the relaying module 20 to be described later will be provided as a wired communication section instead. Further, in such case as above, connection between the phone terminal unit 10 and the relaying module 20 can use a pair of signal lines 40 similarly to the connection between the relaying module 20 and the reporting terminal unit 30.

The reporting terminal unit 30 is provided separately of the phone terminal unit 10 and reports reception of a phone call by the phone terminal unit 10. This reporting of phone call reception can be made in the form of audio reporting or visual reporting. In this embodiment, the reporting terminal unit 30 corresponds to e.g. a car navigation system to be mounted on a vehicle, etc.

The relaying module 20 is connected to the reporting terminal unit 30 via the pair of signal lines 40, thus effecting wired communication therewith. In the instant embodiment, the relaying module 20 and the reporting terminal unit 30 are connected to each other via a pair of car-mounted audio bus cables comprised of a pair of twisted cables. Here, the pair of twisted cables refers to a single strand of twisted pair line formed by twisting at least two cables. In the instant embodiment, this pair of twisted cables corresponds to the pair of signal lines 40 described above.

Here, the car-mounted audio bus refers to a mode of connection configured to interconnect various audio devices in a vehicle and capable of effecting data transmission and reception as well as power supply therebetween via a pair of twisted cables. Such car-mounted audio bus is known in the art, so detailed discussion thereof will be omitted herein. In the instant embodiment, in the communication between the relaying module 20 and the reporting terminal unit 30, the pair of signal lines 40 are used as a pair of differential signal lines. Further, power supply from either one of the relaying module 20 and the reporting module 30 to the other is made possible with using the pair of signal lines 40. That is, the handsfree phone call device 1 can be configured to effect power supply with using the pair of signal lines 40 or can also be configured not to effect such power supply.

The pair of signal lines 40 transmit data signals received or transmitted between the relaying module 20 and the reporting terminal unit 30. As described above, the pair of signal lines 40 are used as a pair of differential signal lines. Therefore, between the relaying module 20 and the reporting terminal unit 30, data are transmitted or received therebetween in the form of differential signals via the pair of signal lines 40. Thus, here, the data signals correspond to differential signals. And, these data signals include a received phone call signal transmitted from the phone terminal unit 10 to the relaying module 20. Here, the received phone call signal refers to an electric signal based on a voice call transmitted from another phone terminal unit which is the other party of communication for the phone terminal unit 10.

Further, in addition to the differential signals and power supply described above, the pair of signal lines 40 are capable of transmitting or receiving also a control signal for use in controlling one of the relaying module 20 and the reporting terminal unit 30 by the other thereof, between these relaying module 20 and the reporting terminal unit 30. Such signal can be transmitted/received in the form of a differential signal or a non-differential signal (e.g. a DC signal).

The reporting terminal unit 30, as shown in FIG. 1, includes a speaker 31, a voice signal transmitting section 32 and a wired communication section 33. The speaker 31 outputs navigation information by the navigation system in the form of a voice inside the car. In case it is to be reported in the form of a voice that the above-described phone terminal unit 10 is now receiving a phone call, the voice thereof will be outputted through this speaker 31. The wired communication section 33 is connected to the relaying module 20 via the pair of signal lines 40, and corresponds to an input/output interface for transmitting/receiving communication data to be exchanged with the relaying module 20.

The voice signal transmitting section 32 transmits a voice signal based on the received call signal transmitted via the pair of signal lines 40 to the relaying module 20 via the pair of signal lines 40. The received call signal transmitted via the pair of signal lines 40 means a received call signal included in the data signal transmitted from the phone terminal unit 10 to the relaying module 20 and then from this relaying module 20 to the reporting terminal unit 30. In the reporting terminal unit 30, this received call signal is outputted through the speaker 31. Simultaneously, the reporting terminal unit 30 generates a voice signal converted from the speaker driven signal by a predetermined processing. Here, a voice signal means a waveform which is oscillated according to the kind, strength, pitch etc. of the voice. The voice signal transmitting section 32 transmits the voice signal to the relaying module 20 via the pair of signal lines 40. This voice signal too, like the received call signal described above, is transmitted in the form of a differential signal to the relaying module 20.

In the instant embodiment, the voice signal transmitting section 32 effects frequency modulation on the voice signal and then transmits the resultant signal. With this, even when the voice signal is low in level, it is still possible to increase noise resistance against external noise. Further, it is also possible to restrict occurrence of delay in transmission. The signal generated by the voice signal transmitting section 32 will be transmitted via the wired communication section 33 to the relaying module 20.

The relaying module 20 includes a wireless relaying section 21, the wired relaying section 22, a microphone 23, a demodulating section 24, and an echo cancelling section 25. The wireless relaying section 21 is connected in a wireless manner to the wireless communication section 14 of the phone terminal unit 10 and effects transmission and reception of data between the phone terminal unit 10 and the relaying module 20. The wired relaying section 22 is connected in wired manner to a wired communication section 33 of the reporting terminal unit 30 via the pair of signal lines 40 and effects transmission and reception of data between the reporting terminal unit 30 and the relaying module 20. To this end, the received call signal transmitted from the phone terminal unit 10 to the relaying module 20 will be transmitted by the wired relaying section 22 via the pair of signal lines 40 to the reporting terminal unit 30. The microphone 23 collects a speech voice of the user when this user is unable to make the phone communication with holding the phone terminal unit 10 by hand and converts it into an electric signal. This electric signal will then be transmitted via the wireless relaying section 21 to the phone terminal unit 10 and then transmitted to other phone terminal unit via the communication section 13.

The demodulating section 24 demodulates the signal transmitted from the reporting terminal unit 30 into a voice signal. Namely, the demodulating section 24 extracts a voice signal from the signal transmitted from the reporting terminal unit 30. This voice signal will be used for effecting echo cancelling on the calling side within the relaying module 20. As this echo cancelling is effected by the echo cancelling section 25, the voice signal extracted by the demodulating section 24 is transmitted to the echo cancelling section 25.

The echo cancelling section 25 reduces, with effective utilization of the voice signal, an echo generated when the received call signal outputted through the speaker 31 included in the reporting terminal unit 30 is inputted to the microphone 23 included in the relaying module 20. Here, the received call signal outputted through the speaker 31 included in the reporting terminal unit 30 means a received call signal which has been transmitted from the relaying module 20 via the pair of signal lines 40. The voice signal refers to the voice signal demodulated by the demodulating section 24.

Further, in the instant embodiment, to this echo cancelling section 25, a sound other than the received call signal outputted through the speaker 31 will be transmitted from the voice signal transmitting section 32 via the pair of signal lines 40 transmitting the voice signal based on the received call signal. Here, the sound other than the received call signal refers to e.g. a sound relating to a TV or radio broadcasting outputted through the speaker 31 of the reporting terminal unit 30 or a sound inputted to the reporting terminal unit 30 via various kinds of media such as a DVD, etc. The echo cancelling section 25 effectively utilizes such voice signal to cancel the sound outputted through the speaker 31 of the reporting terminal unit 30 and inputted to the microphone 23. As a result, for the sound inputted to the microphone 23, although this sound contains both the sound outputted through the speaker 31 of the reporting terminal unit 30 and the sound or voice of the phone caller, with cancelling of the sound outputted through the speaker 31 with the voice signal, only the sound or voice generated by the phone caller can be transmitted to the phone terminal unit 10.

With the above-described configuration of the handsfree phone call device 1, it becomes possible to cause the reporting terminal unit 30 to report only the call reception by the phone terminal unit 10, thus maintaining the phone call quality favorably during a phone call. Further, since power supply and transmission and reception of various signals are possible via the pair of signal lines 40, it is possible to reduce the number of cables to be used, thus light-weighted configuration being made possible at low costs.

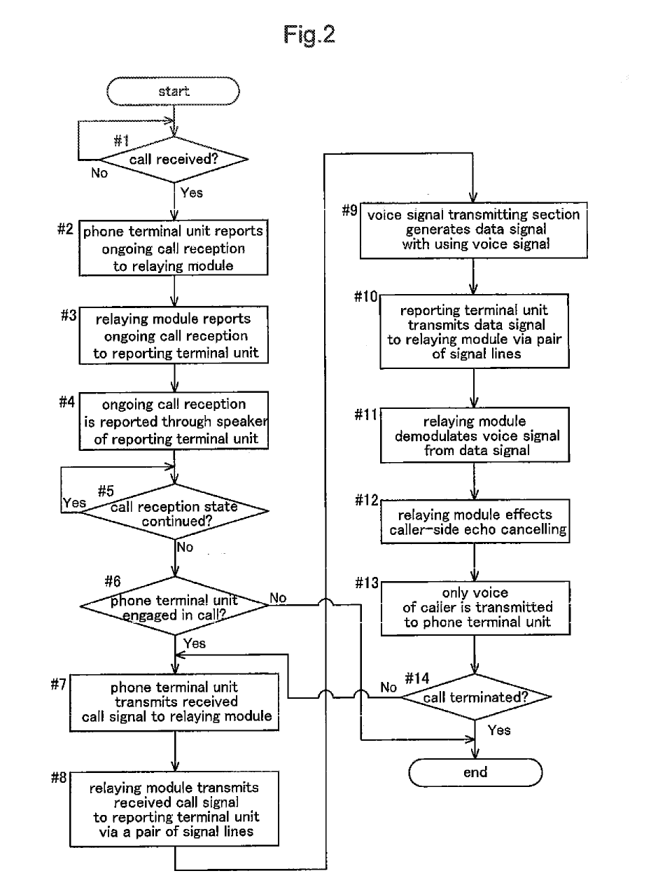

Next, with reference to the flowchart shown in FIG. 2, there will be explained a processing effected by the handsfree phone call device 1 according to the present embodiment. In the following discussion, there will be explained by way of example, a case in which the phone terminal unit 10 and the relaying module 20 effect wireless communication therebetween whereas the relaying module 20 and the reporting terminal unit 30 effect wired communication therebetween and call reception by the phone terminal unit 10 is reported via the relaying module 20 to the reporting terminal unit 30 and this is reported as a voice or sound through the speaker 31 of the reporting terminal unit 30.

When the phone terminal unit 10 receives a phone call (step #1: Yes), the phone terminal unit 10 reports this ongoing call reception to the relaying module 20 (step #2). This reporting is effected between the wireless communication section 14 of the phone terminal unit 10 and the wireless relaying section 21 of the relaying module 20.

Upon reception of reporting from the phone terminal unit 10, the relaying module 20 reports the ongoing call reception to the reporting terminal unit 30 (step #3). This reporting is effected in the form of transmission of a differential signal between the wired relaying section 22 of the relaying module 20 and the wired communication section 33 of the reporting terminal unit 30 via the pair of signal lines 40. Then, the reporting terminal unit 30 reports the ongoing call reception through the speaker 31 of this reporting terminal unit 30 (step #4). This reporting will be continued until termination of call reception state of the phone terminal unit 10 (Yes: step #5).

If the cause of termination of reporting is an ongoing call reception state of the phone terminal unit 10 (step 6: Yes); then, when the phone terminal unit 10 receives a received call signal from another phone terminal unit 10 of the other party, the phone terminal unit 10 will transmit a received call signal to the relaying module 20 (step #7). And, the relaying module 20 transmits this received call signal to the reporting terminal unit 30 via the pair of signal lines 40 (step #8). In this, the received call signal is transmitted as a differential signal.

Upon receiving the differential signal above, the reporting terminal unit 30 converts this differential signal into a received call signal and outputs a voice or sound relating to the received call signal through the speaker 31. Simultaneously therewith, the voice signal transmitting section 32 generates a voice signal based on the speaker driven signal, which voice signal is generated by mixing the received call signal with the signal of the reporting terminal unit 30, thus generating data signal comprised of a differential signal (step #9).

The data signal generated by the voice signal transmitting section 32 is transmitted to the relaying module 20 via the pair of signal lines 40 (step #10). Then, when the relaying module 20 receives data signal from the reporting terminal unit 30, the demodulating section 24 demodulates this by extracting the voice signal from the data signal (#11). The voice signal demodulated by the demodulating section 24 will be used for echo cancelling in the relaying module 20 on the call receiving side (step #12).

The voice outputted through the speaker 31 of the reporting terminal unit 30 will be subjected to cancelling by the echo cancelling section 25 and only the voice of the phone caller will be transmitted to the phone terminal unit 10 (step #13). This processing will be effected until termination of the phone call by the phone terminal unit 10 (step #14: No). If it is determined at step #6 that the termination of the phone call was not caused by entry of the phone terminal unit 10 into phone call receiving state (step #6: No) or if the phone terminal unit 10 terminates the phone call (step #14: Yes), the process will be ended.

### Other Embodiments

In the foregoing embodiment, it was explained that the relaying module 20 and the phone terminal unit 10 are provided separately of each other. Instead, the relaying module 20 can be integrated with the phone terminal unit 10 into a signal unit. Namely, the relaying module 20 can be incorporated within the phone terminal unit 10 or the phone terminal unit 10 can be incorporated within the relaying module 20.

In the foregoing embodiment, it was explained that the reporting terminal unit 30 reports ongoing call reception by the phone terminal unit 10 in the form of a voice or sound. Instead, such ongoing call reception by the phone terminal unit 10 can be reported visually by means of a lamp or illumination or flashing.

In the foregoing embodiment, it was explained that the phone terminal unit 10 and the relaying module 20 effect wireless communication therebetween. Instead, this can be effected in wired manner also.

In the foregoing embodiment, it was explained that the voice signal transmitting section 32 effects frequency modulation on a voice signal for its transmission. Instead, the voice signal transmitting section 32 can utilize amplitude modulation. In such case, it will become possible to eliminate delay in signal transmission. Needless to say, modulation of voice signal by any other technique is also possible. Further alternatively, transmission of voice signal is also possible by such technique I2S (Inter-IC Sound) or TDM (time division multiplexing), etc.

In the foregoing embodiment, it was explained that the pair of signal lines 40 are formed of car-mounted audio bus cables. However, these signal lines 40 can be formed by using any other cables other than the car-mounted audio bus cables as long as such other cables too allow both power supply and differential signal transmission.

In the foregoing embodiment, it was explained that the reporting terminal unit 30 is a car navigation system. Instead, the reporting terminal unit 30 can be a speaker unit constituting the handsfree phone call device 1. Further, the invention is applicable also in a TV conference system or a communication system using a personal computer.

In the foregoing embodiment, it was explained that the echo cancelling section 25 receives transmission of other sound or voice than the received call signal outputted through the speaker 31 as data signal transmitted from the voice signal transmitting section 32. Alternatively, it is also possible to configure such that no other sound than the received call signal outputted through the speaker 31 is transmitted to the echo cancelling section 25.

This disclosure is applicable to a handsfree phone call device configured to output a phone call by a user using a phone terminal unit through a speaker included in the reporting terminal unit.

1. A handsfree phone call device comprising:
a reporting terminal unit that outputs a user's phone call via a phone terminal unit through a speaker;
a relaying module that relays communication between the phone terminal unit and the reporting terminal unit by effecting communication with the phone terminal unit and effecting also wired communication with the reporting terminal unit;
a pair of signal lines that connect between the relaying module and the reporting terminal unit and that also are capable of supplying power from one of the relaying module and the reporting terminal unit to the other;
a wired relaying section included in the relaying module, the wired relaying section transmitting a received call signal transmitted from the phone terminal unit to the relaying module via the pair of signal lines to the reporting terminal unit;
a voice signal transmitting section included in the reporting terminal unit, the voice signal transmitting section transmitting a voice signal based on the received call signal via the pair of signal lines to the relaying module; and
an echo cancelling section included in the relaying module, the echo cancelling section reducing, by means of the voice signal, an echo that is generated when the received call signal outputted through the speaker is inputted to a microphone included in the relaying module.

2. The handsfree phone call device according to claim 1, wherein the pair of signal lines comprise car-mounted audio bus cables.

3. The handsfree phone call device according to claim 1, wherein the voice signal transmitting section transmits the voice signal in the form of a differential signal through the pair of signal lines to the relaying module.

4. The handsfree phone call device according to claim 2, wherein the voice signal transmitting section transmits the voice signal in the form of a differential signal through the pair of signal lines to the relaying module.

5. The handsfree phone call device according to claim 1, wherein the voice signal transmitting section transmits also a voice signal other than the received call signal outputted through the speaker to the relaying module via the pair of signal lines that transmit the voice signal based on the received call signal.

6. The handsfree phone call device according to claim 2, wherein the voice signal transmitting section transmits also a voice signal other than the received call signal outputted through the speaker to the relaying module via the pair of signal lines that transmit the voice signal based on the received call signal.

7. The handsfree phone call device according to claim 3, wherein the voice signal transmitting section transmits also a voice signal other than the received call signal outputted through the speaker to the relaying module via the pair of signal lines that transmit the voice signal based on the received call signal.

8. The handsfree phone call device according to claim 4, wherein the voice signal transmitting section transmits also a voice signal other than the received call signal outputted through the speaker to the relaying module via the pair of signal lines that transmit the voice signal based on the received call signal.

9. The handsfree phone call device according to claim 1, wherein the relaying module comprises a signal unit integrated with the phone terminal unit.

10. The handsfree phone call device according to claim 2, wherein the relaying module comprises a signal unit integrated with the phone terminal unit.

11. The handsfree phone call device according to claim 3, wherein the relaying module comprises a signal unit integrated with the phone terminal unit.

12. The handsfree phone call device according to claim 4, wherein the relaying module comprises a signal unit integrated with the phone terminal unit.

13. The handsfree phone call device according to claim 5, wherein the relaying module comprises a signal unit integrated with the phone terminal unit.

14. The handsfree phone call device according to claim 6, wherein the relaying module comprises a signal unit integrated with the phone terminal unit.

15. The handsfree phone call device according to claim 7, wherein the relaying module comprises a signal unit integrated with the phone terminal unit.

16. The handsfree phone call device according to claim 8, wherein the relaying module comprises a signal unit integrated with the phone terminal unit.
